(19) United States
(12) Patent Application Publication
(10) Pub. No.: US 2005/0271785 A1
(43) Pub. Date: Dec. 8, 2005

(54) Shaped cookie intermediates using bake stable fillings to form visual features

(76) Inventors: Susan M. Hayes-Jacobson, Minneapolis, MN (US); Lanette M. Shaffer, Hudson, WI (US)

Correspondence Address: GENERAL MILLS, INC., P.O. BOX 1113, MINNEAPOLIS, MN, 55440, US

(21) Appl. No.: 11/145,206

(22) Filed: Jun. 2, 2005

Related U.S. Application Data
(60) Provisional application No. 60/577,443, filed on Jun. 3, 2004.

(51) Int. Cl. A23G 3/00

(52) U.S. Cl. 426/549

(57) ABSTRACT

A cookie intermediate and a process for forming a cookie intermediate having a visual feature depicted on both a top surface and a bottom surface of the cookie intermediate. A cookie dough and an edible filling are substantially simultaneously extruded such that the edible filling is encased within the cookie dough to form a cookie rope. The cookie rope is sliced such that the edible filling is exposed on both a top and bottom surface of the individually slice cookie intermediates. The extruder includes a die assembly that extrudes the edible filling in a desired shape or configuration such that after slicing, the edible filling displays a visual feature on the top and bottom surfaces of the cookie intermediate.

### FIELD OF THE INVENTION

This application claims the benefit of priority under 35 U.S.C. § 119(e)(1) of a provisional patent application, Ser. No. 60/577,443, filed Jun. 3, 2004, which is incorporated herein by reference in its entirety.

### BACKGROUND OF THE INVENTION

Due to the demands and stresses of modern life, many people no longer have the time or the desire to create meals or desserts from scratch. Instead, people often purchase ready-to-eat products that are prepared for immediate consumption without further preparation or ready-to-bake products that are prepared so as to go directly from the pantry, refrigerator or freezer to the oven or other associated baking appliance.

One ready-to-bake product that continues to gain in popularity is ready-to-bake cookies, which can go from a refrigerated or frozen dough state to a freshly prepared, hot dessert in a matter of minutes. As the only preparation required is to place a cookie intermediate on a cooking sheet and pre-heat the oven, ready-to-bake cookies can be quickly and easily prepared as a fresh dessert to compliment a meal or as an in-between meal snack. Not only can fresh cookies be prepared in just a few minutes, the consumer can be assured that the taste and general appearance will be of a consistent quality without any concern for possible errors from preparation of the cookies from scratch.

Some ready-to-eat cookie intermediates include internal design elements to further the visual appeal of the cookies. By using multiple colored doughs to form the cookie intermediate, various internal designs can be added such as words, shapes, symbols, characters and logos. In addition to having differing colors, doughs can have different flavors or textures to further promote enjoyment of a baked cookie. For example, a cookie product can have a distinct region with a crisp texture and a distinct region with a chewy texture by using dough with unique saccharide mixtures as disclosed in U.S. Pat. No. 4,752,484 to Pflaumer et al.

One method by which a plurality of colored doughs can be used to form a cookie intermediate with an integral design is disclosed in U.S. Pat. No. 5,620,713 to Rasmussen, which teaches a dough extrusion die having multiple dough paths for extruding a desired design element within a defined boundary. When a continual rope of cookie dough is extruded, as taught by Rasmussen, the visual appearance of the cookie intermediate is consistent throughout the cross-section of the cookie intermediate following the cutting of the dough rope to form individual cookie intermediates. Once the individual cookie intermediates are formed, the plurality of colored doughs comprising the cookie intermediate are each exposed on both a top and a bottom surface of the cookie intermediate.

While the use of a plurality of alternatively colored doughs allows the formation of cookie intermediates with integral design elements, it would be advantageous to use other edible components that not only depict internal design elements but which simultaneously improved the taste of a finished cookie.

### SUMMARY OF THE INVENTION

The invention addresses the aforementioned need by providing a process for forming ready-to-bake cookie intermediates in which internal visual features are formed using bake stable edible fillings. A cookie dough and an edible filling are substantially simultaneously extruded to form a continuous dough rope. A suitable extruder includes a die assembly that extrudes the edible filling in a desired shape or configuration with respect to the cookie dough. The dough rope is then sliced to form individual cookie intermediates such that the edible filling is displayed on both a top and bottom surface of the cookie intermediate. In some embodiments, a plurality of edible fillings can be substantially simultaneously extruded such that they cooperatively define the visual feature. The edible filling generally has a color that differs from the cookie dough. In addition to visually enhancing the cookie intermediate, the edible filling can include flavorings, such as fruit based flavorings, chocolate, peanut butter, caramel, marshmallow and the like, to enhance the overall taste of a baked cookie.

In one aspect, the invention comprises a cookie intermediate formed of a cookie dough and at least one bake-stable filling wherein the filling defines a visual feature, form, symbol or picture viewable on both the top and bottom surfaces of the cookie intermediate and is continuous throughout the internal portion of the cookie intermediate.

In another aspect, the invention comprises a process for forming a cookie intermediate comprising a cookie dough and at least one edible filling such that a visual feature is defined by the edible filling on both a top surface and a bottom surface of the cookie intermediate.

The above summary of the various embodiments of the invention is not intended to describe each illustrated embodiment or every implementation of the invention. The figures in the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a top view of an embodiment of a cookie dough intermediate of the invention.

FIG. 2 is a bottom view of the cookie dough intermediate of FIG. 1.

FIG. 3 is a perspective, top view of the cookie dough intermediate of FIG. 1.

FIG. 4 is a process schematic depicting a method for forming the cookie dough intermediate of FIG. 1.

FIG. 5 is a top view of another embodiment of a cookie dough intermediate of the invention.

FIG. 6 is a top view of another embodiment of a cookie dough intermediate of the invention.

FIG. 7 is a top view of another embodiment of a cookie dough intermediate of the invention.

FIG. 8 is a top view of another embodiment of a cookie dough intermediate of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

As used herein, the term “cookie intermediate” refers to an article that is in an intermediate condition and requires further thermal processing such as baking, cooking or frying to change the intermediate into a condition, for example a cookie, that is suitable for consumption by a consumer.

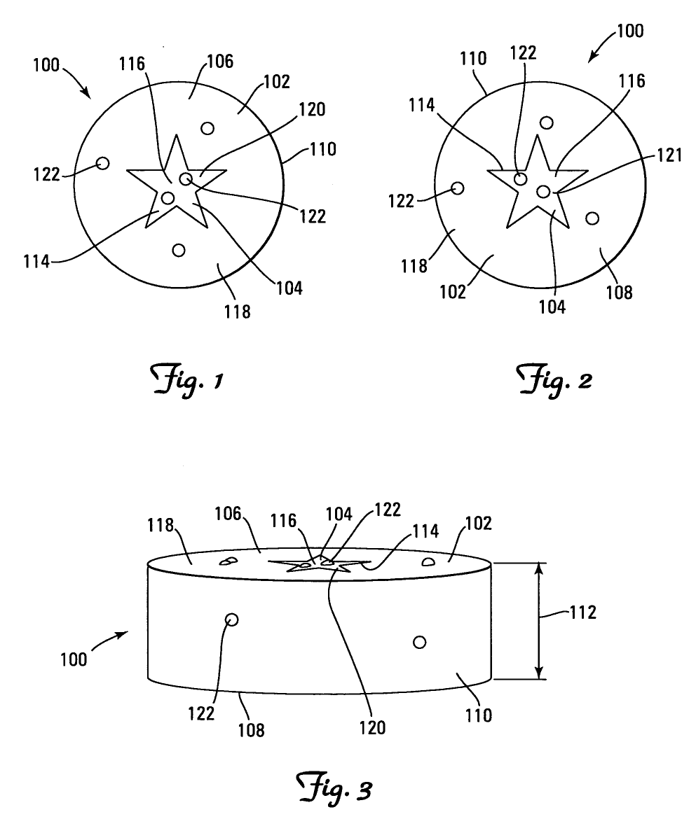

A ready-to-bake cookie intermediate 100 is illustrated in FIGS. 1, 2 and 3. Cookie intermediate 100 is comprised of a cookie dough 102 and at least one bake-stable edible filling 104. Cookie intermediate 100 has a generally, flat, cylindrical appearance with a top surface 106, a bottom surface 108 and a perimeter surface 110. Perimeter surface 110 defines an intermediate thickness 112, which can vary between .125 and 2.0 inches. As shown in FIG. 1, cookie dough 102 generally defines an intermediate shape bounded by the perimeter surface 110. Generally, the edible filling 104 is surrounded by the cookie dough 102 such that the edible filling 104 does not extend to or interact with perimeter surface 110.

As shown in FIG. 1, edible filling 104 can be used to define an internal visual feature, form, symbol or picture 114, for example shapes, words or other visual objects such as a star 116. To define the internal visual feature 114, cookie dough 102 is given a first color 118 while the edible filling 104 is given a second color 120. In addition to variances in color, cookie dough 102 can be distinguishable from edible filling 104 by taste, texture and consistency. In addition to cookie dough 102 and edible filling 104, cookie intermediate 100 can also include edible particulates 122. Edible particulates 122 can comprise any suitable and desirable edible particulate, for example, flavored chips such as chocolate, peanut butter or butterscotch flavored chips, flavored particulates such as coconut and cream cheese bits, candies, nuts, fruit, granola and the like, either whole, sectioned or crushed configurations, that are added to supplement and enhance the visual, taste or textural characteristics of baked goods. Edible particulates 122 can be included so as to remain an integral component of the cookie intermediate 100 through baking and consumption by a consumer or may include items designed to dissolve into either the cookie dough 102 or edible filling 104 during storage or baking such that individual particulates are not noticeable during consumption of a baked cookie. For example, a modified jimmy or sprinkle, can be formulated to dissolve away within the cookie dough 102 or edible filling 104, leaving behind a color source, such as a food dye, or a flavoring where the particulate had previously resided. In this manner, edible particulates 122 can be used to impart visual or flavor characteristics.

Cookie dough 102 generally contains a grain constituent that contributes to the structure of the dough. Different grain constituents lend different texture, taste and appearance to a baked good. Wheat flour is the most commonly used grain constituent in baked goods and in most baked foods is the primary ingredient. Alternatively, other flours such as corn flour, rice flour and the like can be used individually or in combination with wheat flour as the grain constituent. Depending upon dietary requirements, cookie dough 102 can comprise a flourless composition, such as flourless peanut butter cookie dough, in which the grain constituent is replaced primarily with peanut butter, sugar and egg.

The cookie dough 102 of the invention also generally includes one or more leavening agents to provide desirable flow properties during baking, resulting in a baked product of desired shape. Any conventional leavening agent can be utilized in accordance with the invention, for example, sodium bicarbonate, phosphates (such as disodium dihydrogen pyrophosphate or sodium aluminum phosphate), and the like. Baking powder, which comprises a mixture of at least one bicarbonate or carbonate salt, at least one acidifying agent and at least one separating agent can also be used. Preferably, sodium bicarbonate is used with sodium diphosphate or disodium dihydrogen pyrophosphate, and a starch as a separating agent. These mixtures are commercially available with a fixed composition. In one embodiment, sodium bicarbonate can be used alone, in an amount in the range of about 0.2% to about 0.7%. A preferred leavening system is a combination of sodium bicarbonate and sodium aluminum phosphate.

The cookie dough 102 of the invention can also contain additional ingredients. Some such additional ingredients can be used to modify the texture of the dough. Texture modifying agents can improve many properties of the dough, such as viscoelastic properties, plasticity, or dough development. Examples of texture modifying agents include fats, emulsifiers, hydrocolloids, egg products and the like.

Shortening also helps to improve the volume, grain and texture of the final product. Shortening also has a tenderizing effect and improves overall palatability and flavor of a baked good. Natural shortenings, animal or vegetable, or synthetic shortenings can be used. Generally, shortening is comprised of triglycerides, fats and fatty oils made predominantly of triesters of glycerol with fatty acids. Fats and fatty oils useful in producing shortening include cotton seed oil, ground nut oil, soybean oil, sunflower oil, grapeseed oil, sesame oil, olive oil, corn oil, safflower oil, palm oil, palm kernel oil, coconut oil, or combinations thereof.

Emulsifiers include nonionic, anionic, and/or cationic surfactants that can be used to influence the texture and homogeneity of a dough mixture, increase dough stability, improve eating quality, and prolong palatability. Emulsifiers include compounds such lecithin, mono- and diglycerides of fatty acids, propylene glycol mono- and diesters of fatty acids, glyceryl-lacto esters of fatty acids, ethoxylated mono- and diglycerides and the like.

Hydrocolloids can be added to dough formations to increase moisture content, and to improve viscoelatsic properties of the dough and the crumb texture of the final product. Hydrocolloids function both by stabilizing small air cells within the batter and by binding to moisture within the dough. Hydrocolloids include compounds such as xanthan gum, guar gum, locust bean gum, carageenan, alginate, and the like.

Cookie dough 102 can also include flavoring such as sweeteners, spices and specific flavorings such as fruit, vanilla, butter, mint and the like. Sweeteners include regular and high fructose corn syrup, sucrose (cane or beet sugar), dextrose, maltose and reduced sucrose sweeteners such as a saccharide system comprising a crystalline sugar alcohol and either a liquid sugar alcohol or long chain sugar complex. In addition to flavoring the baked good, sweeteners such as sugar can increase the moisture retention of a baked good, thereby increasing its tenderness.

Cookie dough 102 can further include preservatives and mold inhibitors such as sodium salts of propionic or sorbic acids, sodium diacetate, vinegar, monocalcium phosphate, lactic acid and mixtures thereof.

The consistency of cookie dough 102 must be monitored. If cookie dough 102 is too sticky, cookie dough 102 can suffer problems during extrusion and extreme deformation during further processing. If cookie dough 102 is too dry, cookie dough 102 can also suffer extrusion difficulties as well as consumer satisfaction related issues such as taste and texture issues. Cookie dough 102 must have a consistency satisfying both the processing and consumer satisfaction requirements. In an embodiment of the invention, the amount of sugar, shortening flour and moisture is adjusted to achieve the desired dough consistency. If the proper formulation and consistency for cookie intermediate 100 is not achieved or maintained, cookie dough 102 can either spread or fail to spread to an unsatisfactory extent, thereby mitigating the aesthetic appearance and value of the cookie intermediate 100.

In one illustrative embodiment, cookie dough 102 can be formulated as follows:

| INGREDIENT | WEIGHT % |
|---|---|
| Sugar | 28.91 |
| Shortening | 22.21 |
| Water | 1.0 |
| Salt | 0.51 |
| Flour | 35.53 |
| Butter Flavor | 0.69 |
| Liquid Egg | 10.21 |
| Monocalcium Phosphate | 0.38 |
| Soda | 0.56 |
| Total | 100.00 |

All percentages and ratios are calculated by weight unless otherwise indicated. All percentages and ratios are calculated based on the total composition unless otherwise stated.

Edible filling 104 can comprise many of the same ingredients as cookie dough 102. Most typically, edible filling 104 will include substantially increased amounts of flavorings, such as sweeteners and flavorings as compared to cookie dough 102. Sweeteners can include components such as sugar, corn syrup and molasses while flavoring can include components such as cinnamon, cocoa, fruit based flavoring, and other suitable flavorings. Also, edible filling 104 generally includes significantly less grain constituent, or flour, than cookie dough 102. The consistency of edible filling 104 must be firm enough that edible filling 104 is not free flowing but instead will remain in place during extrusion and cutting. Furthermore, edible filling 104 must be formulated such that during baking, the edible filling 104 spreads equivalently to the cookie dough 102 and does not boil out of cookie dough 102. In addition, edible filling 104 should be formulated such that it does not stick to cutting devices or packaging. In one illustrative embodiment, edible filling 104 can be formulated to be a cinnamon flavored filling as follows:

| INGREDIENT | WEIGHT % |
|---|---|
| Sugar | 44.68 |
| Shortening | 14.70 |
| Water | 13.02 |
| Cinnamon | 8.27 |
| Corn Syrup | 7.50 |
| Molasses | 4.80 |
| Flour | 2.00 |
| Starch | 1.95 |
| Whey | 1.76 |
| Albumen | 0.73 |
| Salt | 0.59 |
| Total | 100.00 |

For cookie dough 102 and edible filling 104 to be compatible with respect to finished baked products, it is preferred that cookie dough 102 and edible filling 104 have substantially equivalent water activities (A_{w}) such that water does not migrate between cookie dough 102 and edible filling 104 during storage, which can lead to portions of a baked cookie being dry or wet and reducing the level of enjoyment of the consumer. Preferably, the water activity for both cookie dough 102 and edible filling 104 are within a range of 0.7 to 0.87. The water activities of the dough and filling can differ by 0.05 or less.

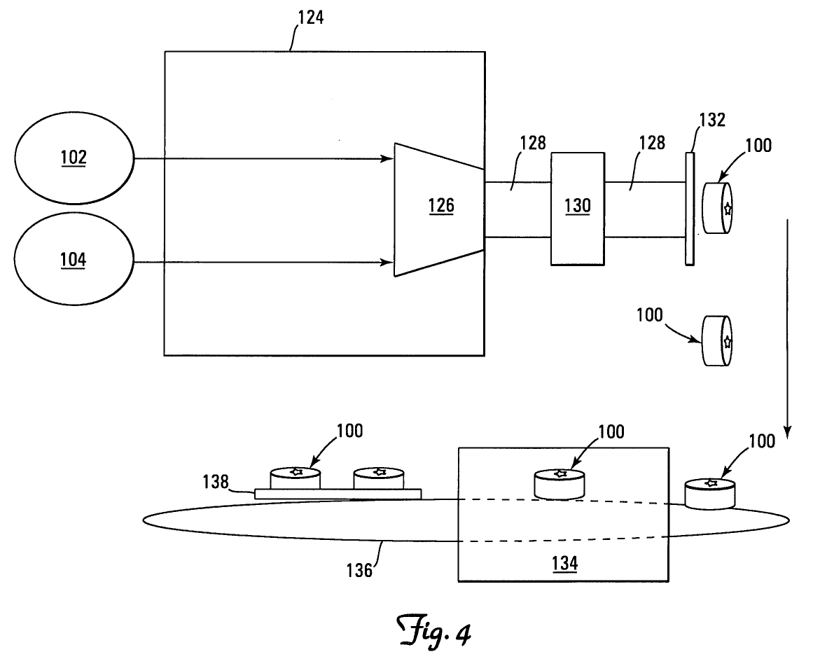

One method for forming cookie intermediate 100 is illustrated in FIG. 4. In general, cookie dough 102 and edible filling 104 can be simultaneously fed into an extruder 124. Extruder 124 can be of a conventional design, for example extruders of the type currently sold by Bepex GMBH of Leingarten, Germany. Within the extruder 124, cookie dough 102 and edible filling 104 are extruded through a die assembly 126. Die assembly 126 includes various openings such that a continuous dough rope 128 is formed as the cookie dough 102 and edible filling 104 pass through the die assembly 126. In general, the extrusion process is accomplished by the apparatus and methods described in U.S. Pat. No. 5,620,713 to Rasmussen. As the extrusion process forms the dough rope 128, the edible filling 104 and any edible particulates 122 form the desired visual feature 114 continuously throughout the length of dough rope 128 as dictated by the die assembly 126. While extruder 124 is depicted with only a single die assembly 126, it will be obvious to one skilled in the art that extruder 124 could include a plurality of die assemblies such that a multiplicity of dough ropes could be formed simultaneously based upon production requirements.

As dough rope 128 exits the extruder 124, the dough rope 128 is optionally directed through a cooling tunnel 130. Within cooling tunnel 130, the exterior of dough rope 128 is cooled such that deformation of the dough shape is prevented during further processing of dough rope 128. Dough rope 128 is generally exposed to cooling conditions only long enough to cool the exterior portions of dough rope 128 such that the interior portions of dough rope 128 are not substantially cooled.

As dough rope 128 exits the cooling tunnel 130, the dough rope 128 is directed past a cutting member 132. In one example embodiment, cutting member 132 can comprise an ultrasonic cutting assembly comprised of blades and an ultrasonic generator operating between a frequency of 20 kHz to 50 kHz. With an ultrasonic cutting assembly, dough rope 128 can be selectively sliced to form cookie intermediate 100 by slicing through perimeter surface 110 such that deformation of cookie intermediate 100 is substantially eliminated as physical contact between more traditional cutting tools such as razor blades and knives is eliminated. Depending upon the consistency of dough rope 128, razor blades and knives can stick or adhere to top surface 106 and bottom surface 108 as dough rope 128 is sliced creating unsatisfactory cutting results with respect to the overall appearance of cookie intermediate 100, such as in the overall size and shape as well as the appearance of visual feature 114.

After cookie intermediate 100 is formed by the cutting of dough rope 128, cookie intermediate 100 can be cooled for storage, such as by directing cookie intermediate 100 through a freezing tunnel 134 using, for example, a conveyor system 136 or positioned on trays and placed in a traditional batch freezer or refrigerator. Either prior to after entering freezing tunnel 134, cookie intermediate 100 can be placed on a packaging intermediate 138.

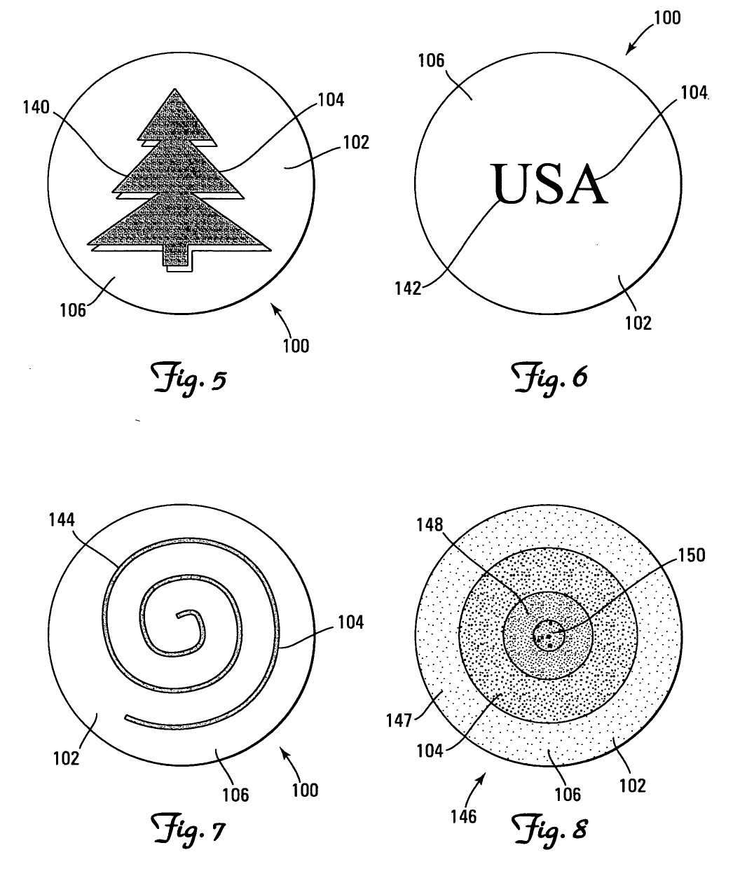

FIGS. 5, 6, 7 and 8 illustrate representative embodiments of cookie intermediate 100 having alternative visual displays. For example, visual display 114 can be representative of traditional holiday symbols such as Christmas tree 140 shown in FIG. 5. Alternatively, visual display can comprise other holiday symbols such as Jack-O-Lanterns for Halloween, flags for Independence Day, hearts for Valentines Day, shamrocks for St. Patrick's Day, bunny rabbits for Easter and other suitable holiday symbols. Visual display 114 can also comprise textual symbols such as abbreviations and logos, for example, abbreviation 142 for the United States of America as shown in FIG. 6. Visual display 114 can take the form of miscellaneous shapes or patterns, for example swirl 144 as shown in FIG. 7. Finally, die assembly 126 can be configured to extrude an embodiment of a cookie intermediate 146 depicting a visual pattern, for example a bull's-eye 147, using additional, alternatively colored or flavored edible fillings, for example a second edible filling 148 and a third edible filling 150, as illustrated in FIG. 8.

Although various embodiments of the present invention have been disclosed here for purposes of illustration, it should be understood that a variety of changes, modifications and substitutions may be incorporated without departing from either the spirit or scope of the present invention.

1. A method of forming a dough based cookie intermediate comprising:
extruding substantially simultaneously a first dough and at least one bake stable filling substantially encased within said first dough to form a dough rope; and
slicing the dough rope to form the cookie intermediate such that the at least one bake stable filling is exposed on a top surface and a bottom surface of the cookie intermediate.

2. The method of claim 1, further comprising cooling the dough rope prior to slicing the dough rope.

3. The method of claim 1, wherein the first dough and the at least one bake stable filling are substantially simultaneously extruded through an extrusion die to form a visual feature within the dough rope.

4. The method of claim 3, wherein the visual feature is selected from the group comprising holiday symbols, fictitious characters, logos, words, swirls, geometric shapes and pictures.

5. The method of claim 1, wherein a second bake stable filling is extruded in conjunction with the cookie dough and first bake stable filling such that the second bake stable filling is encased within the cookie dough.

6. The method of claim 1, further comprising cooling the cookie intermediate prior to storage.

7. The method of claim 1, wherein the dough rope is ultrasonically sliced using an ultrasonic cutting member operating between a frequency of about 20 kHz to about 50 kHz.

8. The method of claim 1, wherein a plurality of edible particulates is included in one or both of the cookie dough and the at least one bake stable filling.

9. The method of claim 8, wherein the particulates are selected from the group consisting of whole or bit portions of flavored chips, candy, fruit, nuts, marshmallows or dry cereals.

10. The method of claim 1, wherein the at least one bake stable filling is selected from the group consisting of a fruit based filling, a chocolate filling, a peanut butter filling, a caramel filling, a nut based filling, a vanilla filling, or a marshmallow filling.

11. A cookie intermediate comprising:
a first cookie dough unit defining a top surface, a bottom surface and a perimeter surface; and
at least a first bake stable filling partially surrounded by the cookie dough, the first edible filling being present in a continuous manner between the top surface and the bottom surface such that a visual feature is exposed on both the top surface and the bottom surface of the cookie intermediate.

12. The cookie intermediate of claim 11, wherein either or both the cookie dough and the first bake stable filling include a plurality of edible particulates.

13. The cookie intermediate of claim 12, wherein the plurality of edible particulates is selected from the group comprising whole or bit portions of flavored chips, candy, fruit, nuts, marshmallows or dry cereals.

14. The cookie intermediate of claim 11, wherein the first bake stable filling is selected from the group comprising a fruit based filling, a chocolate filling, a peanut butter filling, a caramel filling, a nut based filling, a vanilla filling, or a marshmallow filling.

15. The cookie unit of claim 11, wherein the visual feature is selected from the group comprising holiday symbols, fictitious characters, logos, abbreviations, words, swirls, geometric shapes and pictures.

16. The cookie intermediate of claim 11, further comprising a second bake stable filling partially surrounded by the cookie dough, the second bake stable filling being present in a continuous manner between the top surface and the bottom surface such that the first edible filling and the second edible filling cooperatively define the visual feature on both the top surface and the bottom surface of the cookie intermediate.

17. The cookie intermediate of claim 11 wherein the cookie dough has a dough water activity and the bake stable filling has a filling water activity and wherein the dough water activity and the filling water activity are both within a range of 0.7 and 0.87.

18. The cookie intermediate of claim 17 wherein the filling water activity and the dough water activity differ by 0.05 or less.
